(19) United States
(12) Patent Application Publication
(10) Pub. No.: US 2023/0227185 A1
(43) Pub. Date: Jul. 20, 2023

(54) AN AERIAL VEHICLE

(71) Applicant: GRIFF AVIATION AS, SYKKYLVEN (NO)

(72) Inventors: Jan Martin NYSÆTER, Sykkylven (NO); Hallvard Ellingsen TYLDUM, Âlesund (NO)

(21) Appl. No.: 17/780,916

(22) PCT Filed: Dec. 9, 2020
(86) PCT No.: PCT/NO2020/050308

§ 371 Date: May 27, 2022

(30) Foreign Application Priority Data
Dec. 11, 2019 (NO) 20191467

(51) Int. Cl. B64U 50/39; B64U 10/10; B64U 20/83; B64U 20/60; B64U 20/77

(52) U.S. Cl. CPC B64U 50/39; B64U 10/10; B64U 20/83; B64U 20/60; B64U 20/77; B64U 10/30

(57) ABSTRACT

An aerial vehicle comprising: at least three support arms for interconnecting at least three motors; at least one battery module; at least one of the support arms is configured to support the at least one battery module such that the battery module forms a structural element of the support arm.

The present invention relates to aerial vehicles, and is particularly applicable for unmanned aerial vehicles (UAV), such as drones.

### BACKGROUND

Aerial vehicles referred to as multicopters are rotorcrafts comprising spaced-apart motors controlling respective rotors. The motors may be spaced apart and connected to a body by support arms.

A critical aspect of an aerial vehicle is weight. The lighter the aerial vehicle, the more lifting capacity it may have, and a longer flight-time may be achieved. One of the io heavier components of an aerial vehicle is the battery, and there are limitations in how light-weight a battery can be designed without affecting the performance. As such, design of aerial vehicles today are on a large part based on weight-effective designs.

Another critical aspect of an aerial vehicle is rigidity. Upon acceleration and maneuvering, the rotors may greatly stress the motors and support arms, and a rigid construction is key as it enhances response and control of the aerial vehicle.

The prior art includes US 2018/099756 A1 and WO 2018/058004 A1, which describe battery modules for unmanned and human piloted electric aircraft. The modules comprise two planar substrates with electrochemical cells secured between to form load-bearing structural components from which aircraft with greater endurance can be constructed. Battery modules can be formed to the shapes of aircraft parts such as wings. Multirotor aircraft are disclosed in which the arms and other parts of the aircraft are constructed from such battery modules.

The prior art also includes WO2017/197239 A1, which describes an unmanned aerial vehicle with multiple rotor arms. A rotor is disposed at an end of each rotor arm, and an adjustment component is configured to enable a first rotor arm to move relative to a second rotor arm.

The prior art also includes US 2018/327090 A1, which describes a drone comprising a central body and a plurality of arms. Each arm comprises a first end mounted on the central body and, in the vicinity of a second end, at least one electric motor and propeller. Each arm accommodates at least one electric battery.

The prior art also includes CN208233336U, which describes an unmanned aerial vehicle having a battery installed in a chamber in an arm.

It is therefore a need for an improved aerial vehicle that reduces the weight and increases the rigidity of such vehicles. It is a further advantage to devise an aerial vehicle formed from cost-effective components. It is an objective of the present invention to achieve this and to provide further advantages over the state of the art.

### SUMMARY

It is an object of the present invention to mitigate, alleviate or eliminate one or more of the above-identified deficiencies and disadvantages in the prior art and solve at least the above mentioned problem.

It is therefore provided an aerial vehicle comprising;

at least three support arms for interconnecting at least three motors,

at least one battery module interchangeable through an opening on an end of at

least one support arm,

characterized in that:

the at least one battery module comprises at least one arm interconnection portion configured for interconnection with at least one battery interconnection portion on the at least one support arm as the battery module is inserted into the support arm through the opening,

the support arm is configured for supporting the battery module such that the battery module forms a structural element of the support arm.

According to an embodiment of the invention, the at least one battery module is housed within the at least one support arm.

According to an embodiment of the invention, the at least three support arms comprise extruded profiles.

According to an embodiment of the invention, the at least one arm interconnection portion extends generally along the length of the at least one battery module.

According to an embodiment of the invention, the at least one battery module comprises four arm interconnection portions and the at least one support arm comprises four battery interconnection portions.

According to an embodiment of the invention, each support arm is configured for supporting a battery module.

According to an embodiment of the invention, the arm interconnection portion comprises a slider profile, and the battery interconnection portion comprises a slot profile, or vice versa.

The battery module may comprise an extruded aluminum profile.

According to an embodiment of the invention, the battery module comprises a rectangular or squared cross-section, with an arm interconnection portion at each corner of the rectangular or squared cross-section. The battery module may comprise a rectangular cross-section with two first parallel sides and two second parallel sides, the second sides are longer that the first sides and the second sides are arranged in a generally nominal vertical orientation.

The present invention will become apparent from the detailed description given below. The detailed description and specific examples disclose preferred embodiments of the invention by way of illustration only. Those skilled in the art understand from guidance in the detailed description that changes and modifications may be made within the scope of the invention.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an” and “the” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present invention, will be more fully appreciated by reference to the following illustrative and non-limiting detailed description of example embodiments of the present invention, when taken in conjunction with the accompanying figures.

FIG. 1 shows a perspective view of an embodiment of an aerial vehicle comprising support arms. A battery module is inserted into a support arm through an opening.

FIG. 2 shows a perspective view of an embodiment of an elongate battery module for an aerial vehicle.

FIG. 3 shows a section view through a support arm and a battery module.

### DETAILED DESCRIPTION

The present invention will now be described with reference to the accompanying figures, in which preferred example embodiments of the invention are shown. The invention may, however, be embodied in other forms and should not be construed as limited to the herein disclosed embodiments. The disclosed embodiments are provided to fully convey the scope of the invention to the skilled person.

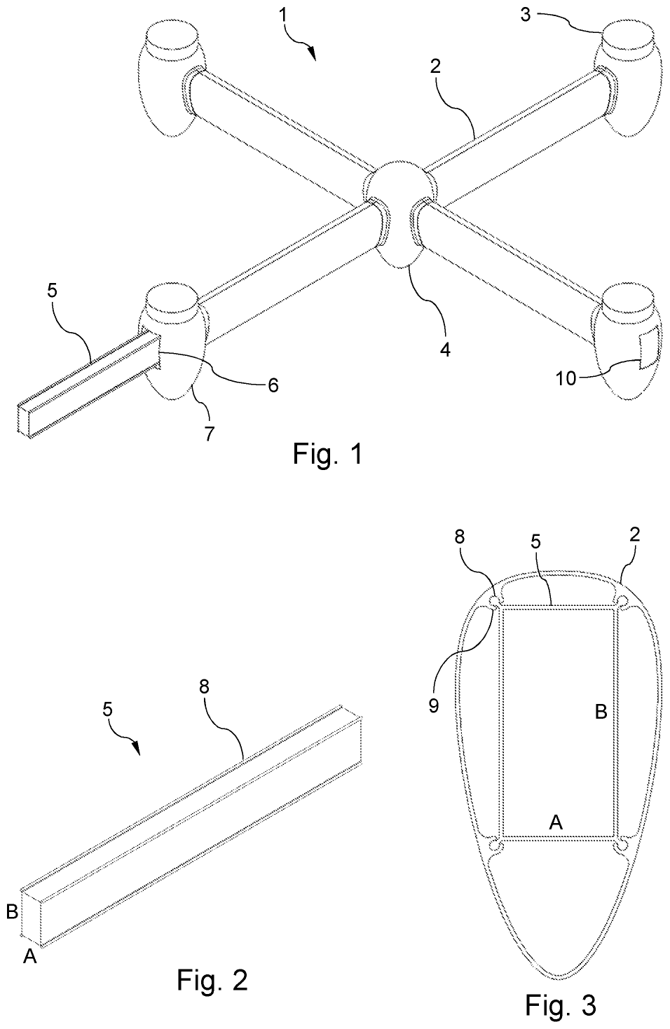

Referring initially to FIG. 1, an embodiment of an aerial vehicle 1 is shown. The aerial vehicle 1 comprises support arms 2 connecting motors 3 to a body 4. During normal operation, rotors are connected to the motors as a skilled person would appreciate, but the rotors are not visualized in the illustrated embodiment. One rotor would typically be connected to each motor. The aerial vehicle may be an unmanned aerial vehicle, such as a drone.

In the illustrated embodiment, the aerial vehicle 1 comprises four support arms 2, connecting four motors 3. The aerial vehicle 1 may comprise at least three support arms 2 for connecting at least three motors 3, and the aerial vehicle 1 may as such comprise any number of support arms 2 connecting any number of motors 3. The motors 3 may be positioned at an end portion of the support arms 2, as in the illustrated embodiment. The support arms 2 may be extruded aluminum profiles that are cost effective to manufacture. The support arms 2 thus have a constant cross-section, and the support arms 2 may have an airfoil shape, as is better visualized in FIG. 3. The airfoil shape minimizes air drag as the aerial vehicle 1 is moved upwards.

The aerial vehicle 1 in the illustrated embodiment comprises a body 4 to which the support arms 3 are connected. The body 4 is in the illustrated embodiment a connection point between the support arms 2, but may in other embodiments be a voluminous body or a hull. The support arms 2 may alternatively span from one motor to another, such as to form an annular structure without a body in the center.

The aerial vehicle 1 comprises at least one battery module 5. In the illustrated embodiment, each support arm 2 comprises a battery module 5, and the weight distribution in the aerial vehicle is thus balanced. The battery modules 5 may be interchangeable, such that when they are discharged they can be replaced by other recharged battery modules. The battery module 5 is elongate, and the support arm 2 is configured for supporting the battery module 5.

The battery module 5 may be inserted into the aerial vehicle 1 through an opening 6 on an end of the support arm 2. The opening 6 is in the illustrated embodiment provided on a motor housing 7, but the opening 6 could as such be anywhere on the support arm 2 or elsewhere. The opening 6 may be sealed by means of a hatch 10 or similar device in order to prevent moisture and dirt from entering the internal space of the support arm 2. Alternatively, the battery module 5 may be shaped such that when it is fully inserted into the support arm the outer portion of the battery module 5 seals shut the opening 6. The battery module 5 may be held in place in the support arm 2 by snap lock means, manually activated locking means or similar locking mechanisms.

In the illustrated embodiment, the battery module 5 is housed within the support arm 2. Alternatively, the support arm 2 may not fully enclose the battery module 5, but the support arm 2 may have an open configuration. The battery module 5 may also be positioned into the support arm 2 from an upper- or underside, or even sideways.

The aerial vehicle 1 of the illustrated embodiment comprises four support arms 2, each supporting one respective motor 3. Each support arm 2 comprises an opening 6 for receiving a battery module 5. When inserted into the support arm 2, the battery module 5 forms a structural element of the support arm 2 and thus increases rigidity to the support arm 2. A structural element is an element of a structure that is exposed to a significant portion of the forces the structure is exposed to. As such, the support arm 2 itself may be constructed lighter and less rigid, because it is dependent on the battery module 5 to be inserted in order to have the stiffness required for the aerial vehicle 1 to function optimally.

Referring now to FIGS. 2 and 3, the battery module 5 is shown isolated in FIG. 2, and a section view through a battery module 5 interconnected with a support arm 2 is shown in FIG. 3.

The battery module 5 may comprise at least one arm interconnection portion 8. The arm interconnection portion 8 is configured for interlocking with a corresponding battery interconnection portion 9 on the support arm 2. In the illustrated embodiment, the arm interconnection portion 8 is a slider profile, and the battery interconnection portion 9 is a slot profile. The slider-and-slot configuration may be arranged vice versa. The arm interconnection portion 8 is configured for interlocking with the battery interconnection portion 9, and in the illustrated embodiment, the arm interconnection portion 8 interlocks with the battery interconnection portion 9 as the battery module 5 is slid into the support arm 2 profile.

The battery module 5 has an integral structural rigidity, and when interconnected with the support arm 2, the structural integrity of the support arm 2 is increased. As such, a support arm 2 interconnected with a battery module 5 may have greatly increased properties regarding at least bending and torsion stiffness.

The battery module 5 may comprise an extruded aluminum profile, and may comprise several battery cells. The arm interconnection portion 8 may be an integrated part of the extruded battery module profile, and the battery interconnection portion 9 may be an integrated part of an extruded support arm profile. One such battery module may weigh approximately 60 kg, and thus add both significant mass and stiffness to an aerial vehicle. The battery module 5 may have both connectors on a common end of the battery module 5, such that the battery module powers the aerial vehicle as soon as it is fully inserted into the support arm 2. The battery modules 5 may be interconnected in the aerial vehicle and act as one power source.

The battery module 5 of the illustrated embodiment has a four sided cross-section. The cross-section along the longitudinal direction of the battery module 5 may thus have a generally rectangular or square outline. In the illustrated embodiment, the rectangular cross-section two parallel sides A and two parallel sides B, and the sides B are longer that the sides A. The longer sides B are arranged in a generally nominal vertical orientation (see FIG. 3). The receptacle inside the arm has a complementary cross-section. The battery module 5 may comprise an arm interconnection portion 8 at each respective corner, and the battery module 5 of the illustrated embodiment thus comprises four arm interconnection portions 8 and the support arms 2 comprises four battery interconnection portions 9. The arm interconnection portions 8 preferably extend along the length of the battery module 5 either in intervals or continuously, such that contact between the battery module 5 and the support arm 2 is maximized in the longitudinal direction of the battery module 5 and support arm 2.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed invention, from a study of the drawings, the disclosure, and the appended claims.

1. An aerial vehicle comprising:
at least three support arms for interconnecting at least three motors; and
at least one battery module interchangeable through an opening on an end of at least one support arm of the at least three support arms,
characterized in that:
wherein the at least one battery module comprises at least one arm interconnection portion configured to interconnect with at least one battery interconnection portion on the at least one support arm as the battery module is inserted into the at least one support arm through the opening, and wherein the at least one support arm is configured to support the battery module such that the battery module forms a structural element of the at least one support arm.

2. The aerial vehicle according to claim 1, wherein the at least one battery module is housed within the at least one support arm.

3. The aerial vehicle according to claim 1, wherein the at least three support arms each comprises extruded profiles.

4. The aerial vehicle according to claim 1, wherein the at least one arm interconnection portion extends along the length of the at least one battery module.

5. The aerial vehicle according to claim 1, wherein the at least one battery module comprises four arm interconnection portions and the at least one support arm comprises four battery interconnection portions.

6. The aerial vehicle according to claim 1, wherein each support arm of the at least three support arms is configured to support the at least one battery module.

7. The aerial vehicle according to claim 1, wherein the arm interconnection portion comprises a slider profile and the battery interconnection portion comprises a slot profile, or wherein the arm interconnection portion comprises the slot profile and the battery interconnection portion comprises the slider profile.

8. The aerial vehicle according to claim 1, wherein the battery module comprises an extruded aluminum profile.

9. The aerial vehicle according to claim 1, wherein the battery module comprises a rectangular or squared cross-section, and wherein an arm interconnection portion is positioned at each corner of the rectangular or squared cross-section.

10. The aerial vehicle according to claim 9, wherein the battery module comprises a rectangular cross-section with two first parallel sides and two second parallel sides, wherein the two second parallel sides are longer that the two first parallel sides, and wherein the two second parallel sides are arranged in a vertical orientation.

11. An aerial vehicle comprising:
at least three support arms configured to interconnect at least three motors;
at least one battery module interchangeable through an opening on an end of at least one support arm of the at least three support arms, wherein the at least one support arm is configured to support the battery module such that the battery module forms a structural element of the at least one support arm; and
at least one arm interconnection portion configured to interconnect with at least one battery interconnection portion on the at least one support arm as the battery module is inserted into the at least one support arm through the opening.

12. The aerial vehicle according to claim 11, wherein the at least one battery module is housed within the at least one support arm.

13. The aerial vehicle according to claim 11, wherein the at least three support arms each comprise extruded profiles.

14. The aerial vehicle according to claim 11, wherein the at least one arm interconnection portion extends along the length of the at least one battery module.

15. The aerial vehicle according to claim 11, wherein the at least one battery module comprises four arm interconnection portions and the at least one support arm comprises four battery interconnection portions.

16. The aerial vehicle according to claim 11, wherein each support arm of the at least three support arms is configured to support the at least one battery module.

17. The aerial vehicle according to claim 11, wherein the at least one arm interconnection portion comprises a slider profile and the battery interconnection portion comprises a slot profile, or wherein the at least one arm interconnection portion comprises the slot profile and the battery interconnection portion comprises the slider profile.

18. The aerial vehicle according to claim 11, wherein the battery module comprises an extruded aluminum profile.

19. The aerial vehicle according to claim 11, wherein the battery module comprises a rectangular or squared cross-section, and wherein an arm interconnection portion is positioned at each corner of the rectangular or squared cross-section.

20. The aerial vehicle according to claim 19, wherein the battery module comprises a rectangular cross-section with two first parallel sides and two second parallel sides, wherein the two second parallel sides are longer that the two first parallel sides, and wherein the two second parallel sides are arranged in a vertical orientation.
